(19) United States
(12) Patent Application Publication
(10) Pub. No.: US 2003/0023967 A1
(43) Pub. Date: Jan. 30, 2003

(54) System and method for surveying broadcasting rating

(76) Inventor: Sang-Soo Kim, Seoul (KR)

Correspondence Address: HARNESS, DICKEY & PIERCE, P.L.C., P.O. BOX 8910, RESTON, VA, 20195, US

(21) Appl. No.: 10/200,216

(22) Filed: Jul. 23, 2002

(30) Foreign Application Priority Data
Jul. 25, 2001 (KR) 2001-44979

(51) Int. Cl. H04H 1/00; H04N 7/16; H04H 9/00

(52) U.S. Cl. 725/9; 455/3.01; 725/14

(57) ABSTRACT

The present invention relates to a system and method for surveying broadcasting rating, for surveying digital broadcasting rating so as to generate broadcasting viewing information and for providing the broadcasting viewing information to an external analysis system for broadcasting rating. To achieve the foregoing, the present invention provides a system for surveying broadcasting rating comprising a first transmission apparatus for receiving transport stream of a channel selected by a user from the digital TV, extracting broadcasting channel tuning information, so as to generate broadcasting viewing information, and for transmitting the broadcasting viewing information to the analysis system for broadcasting rating. The first transmission apparatus is comprised of a first interface part for receiving transport stream of a channel selected by a user form a digital TV; a first decoding part for extracting broadcasting channel tuning information from the transport stream; a first controlling part for controlling the first decoding part for extracting the broadcasting channel tuning information, for receiving the broadcasting channel tuning information, generating broadcasting viewing information, and for controlling the broadcasting viewing information to be transmitted to an analysis system for broadcasting rating; a first storing part for storing the broadcasting viewing information; and a first communicating part for transmitting the broadcasting viewing information to the analysis system for broadcasting rating according to a control of the first controlling part. Therefore, it is possible to survey accurately broadcasting rating for digital broadcasting putting various broadcasting programs in one single frequency band, providing the same to an audience, and it is also possible to survey broadcasting rating in real time when necessary.

### BACKGROUND OF THE INVENTION

1. Field of the Invention

The present invention relates to a system and method for surveying broadcasting rating, for surveying digital broadcasting rating so as to generate broadcasting viewing information and for providing the broadcasting viewing information to an external analysis system for broadcasting rating.

2. Description of the Related Art

For general method for surveying audience rating about broadcasting program, a method using a people meter and a picture matching method are used most frequently.

A method using a people meter is a method for installing a people meter in a sample household selected from a region under survey, and for analyzing broadcasting rating with use of broadcasting viewing information remotely transmitted from the people meter. In case of a method using a people meter, a probe is connected to a TV tuner terminal for detecting frequency conversion, thereby surveying broadcasting rating. But, in case that a plurality of TV programs is broadcasted on one single frequency band as is the case with digital broadcasting, there emerges a problems that exact broadcasting rating cannot be surveyed for TV programs currently watched in a household with merely use of the people meter.

In the meantime, a picture matching method is a method for comparing an image extracted from specific point of a TV screen with a basic image previously stored, thereby determining broadcasting rating. But, in case that a user uses an additional service provided to a predetermined zone of the screen while watching TV program, the image may not correspond to an image of the actual TV program broadcasted, causing a problem that the TV program in question is surveyed not to have been watched.

### SUMMARY OF THE INVENTION

The present invention has been made to solve the above mentioned problems and, therefore, it is an object of the present invention to provide a system and method for surveying broadcasting rating, for receiving transport stream of a channel selected by a user from a digital TV, then extracting broadcasting channel tuning information, and for generating broadcasting viewing information, and for transmitting the broadcasting viewing information to an external analysis system for broadcasting rating by a previously determined interval or in real time.

It is another object of the present invention to provide a system and method for surveying broadcasting rating, for mounting an application outputting a channel conversion controlling information to a digital TV, and for receiving a channel conversion controlling information from the digital TV so as to generate broadcasting viewing information, then to transmit the same to an external analysis system for broadcasting rating by predetermined time interval or in real time.

To accomplish the above objects, a system for surveying broadcasting rating for surveying digital broadcasting rating so as to provide survey results to an external analysis system for broadcasting rating, the system for surveying broadcasting rating as set forth in claim 1, provided as one embodiment of the present invention, is comprised of a first transmission apparatus for receiving transport stream of a channel selected by a user from the digital TV, then extracting broadcasting channel tuning information so as to generate broadcasting viewing information, and for transmitting the broadcasting viewing information to the analysis system for broadcasting rating.

### BRIEF DESCRIPTION OF THE DRAWINGS

The above objects, features and advantages of the present invention will become more apparent from the following detailed description when taken in conjunction with the accompanying drawings, in which:

FIG. 1 is a block diagram illustrating one embodiment of a system for surveying broadcasting rating according to the present invention;

FIG. 2 is a flow chart illustrating a method for surveying broadcasting rating in a system as shown in of FIG. 1;

FIG. 3 is a block diagram illustrating another embodiment of a system for surveying broadcasting rating according to the present invention;

FIG. 4 is a flow chart illustrating a method for surveying broadcasting rating in a system as shown in FIG. 3.

### DETAILED DESCRIPTION OF THE PREFERRED EMBODIMENT

To accomplish the above objects, the present invention as set forth in claim 2, provides a system for surveying broadcasting rating as recited in claim 1, wherein the first transmission apparatus transmits the broadcasting viewing information to the analysis system for broadcasting rating by predetermined time interval or in real time.

Also, to accomplish the above objects, the present invention as set forth in claim 3, provides a system for surveying broadcasting rating as recited in claim 1 or 2, wherein the first transmission apparatus is comprised of a first interface part for receiving a transport stream of the channel from the digital TV; a first decoding part for extracting broadcasting channel tuning information from the transport stream; a first controlling part for controlling the first decoding part for extracting broadcasting channel tuning information, for receiving the broadcasting channel tuning information, generating broadcasting viewing information, and for controlling the broadcasting viewing information to be transmitted to the analysis system for broadcasting rating; a first storing part for storing the broadcasting viewing information; and a first communicating part for transmitting the broadcasting viewing information to the analysis system for broadcasting rating according to a control of the first controlling part.

To accomplish the above objects, the present invention as set forth in claim 4, provides a system for surveying broadcasting rating as recited in claim 3, wherein the first controlling part generates broadcasting viewing information including broadcasting viewing channel, broadcasting viewing time and user information.

To accomplish the above objects, a system for surveying broadcasting rating for surveying a digital broadcasting rating so as to provide survey results to an external analysis system for broadcasting rating, the system for surveying broadcasting rating as set forth in claim 5, provided as another embodiment of the present invention, is comprised of a digital TV having an application for outputting channel conversion controlling information to an internal port; and a second transmission apparatus for receiving the channel conversion controlling information from the digital TV, generating broadcasting viewing information, and for transmitting the broadcasting viewing information to an analysis system for broadcasting rating.

Also, to accomplish the above objects, the present invention asset forth in claim 6, provides a system for surveying broadcasting rating as recited in claim 5, wherein the second transmission apparatus transmits broadcasting viewing information to the analysis system for broadcasting rating by predetermined time interval or in real time.

To accomplish the above objects, the present invention as set forth in claim 7, provides a system for surveying broadcasting rating as recited in claim 5 or 6, wherein the digital TV can be given transplantation of the application from outside through the internal port.

To accomplish the above objects, the present invention as set forth in claim 8, provides a system for surveying broadcasting rating as recited in claim 5 or 6, wherein the second controlling apparatus is comprised of a second controlling part for receiving channel conversion controlling information from the digital TV, generating broadcasting viewing information, and for controlling the broadcasting viewing information to be transmitted to the analysis system for broadcasting rating; a second storing part for storing the broadcasting viewing information; and a second communicating part for transmitting the broadcasting viewing information to the analysis system for broadcasting rating according to a control of the second controlling part.

Also, to accomplish the above objects, the present invention as set forth in claim 9, provides a system for surveying broadcasting rating as recited in claim 8, wherein the second controlling part generates broadcasting viewing information including broadcasting viewing channel, broadcasting viewing time or hour and user information.

To accomplish the above objects, a method for surveying broadcasting rating in a broadcasting rating surveying system having a first transmission apparatus for surveying digital broadcasting rating so as to provide survey results to an external analysis system for broadcasting rating, the method for surveying broadcasting rating as set forth in claim 10, provided as further another embodiment of the present invention, is comprised of the steps of (a) receiving transport stream of a channel selected by a user from a digital TV, extracting broadcasting channel tuning information; (b) receiving the broadcasting channel tuning information, generating broadcasting viewing information; and (c) transmitting the broadcasting viewing information to the analysis system for broadcasting rating.

To accomplish the above objects, the present invention as set forth in claim 11, provides a method for surveying broadcasting rating as recited in claim 10, wherein the step of (c) transmits the broadcasting viewing information to the analysis system for broadcasting rating by predetermined time interval or in real time.

To accomplish the above objects, the present invention as set forth in claim 12, provides a method for surveying broadcasting rating as recited in claim 10 or 11, wherein the step of (b) generates broadcasting viewing information including broadcasting viewing channel, broadcasting viewing time and user information.

To accomplish the above objects, a method for surveying broadcasting rating in a broadcasting rating surveying system having a digital TV and a second transmission apparatus for surveying a digital broadcasting rating so as to provide survey results to an external analysis system for broadcasting rating, the method for surveying broadcasting rating as set forth in claim 13, provided as still further another embodiment of the present invention, is comprised of the steps of (a) transplanting, through an internal port, an application for outputting channel conversion controlling information to the internal port of the digital TV; (b) the second transmission apparatus receiving the channel conversion controlling information from the digital TV, generating broadcasting viewing information,; and (c) transmitting the broadcasting viewing information to the analysis system for broadcasting rating.

Also, to accomplish the above objects, the present invention as set forth in claim 14, provides a method for surveying broadcasting rating as recited in claim 13, wherein the step of (c) transmits the broadcasting viewing information to the analysis system for broadcasting rating by predetermined time interval or in real time.

To accomplish the above objects, the present invention as set forth in claim 15, provides a method for surveying broadcasting rating as recited in claim 13 or 14, wherein the step of (b) generates broadcasting viewing information including broadcasting viewing channel, broadcasting viewing time or hour and user information.

The above objects, features and advantages of the present invention will be more easily understood with reference to the accompanying drawings and the following detailed description. The present invention provides, as a preferred embodiment, a method and supporting system for surveying a digital broadcasting rating so as to generate broadcasting viewing information and for providing the broadcasting viewing information to an external analysis system for broadcasting rating.

A preferred embodiment of the present invention includes embodiments such as a computer system and a computer program product programmed to perform a method of the present invention. In case of embodiment of a computer system, command set for performing the method resides on one or more memory and this command set may be stored in a memory such as a hard disk as a computer program until the computer system is in need of the command set.

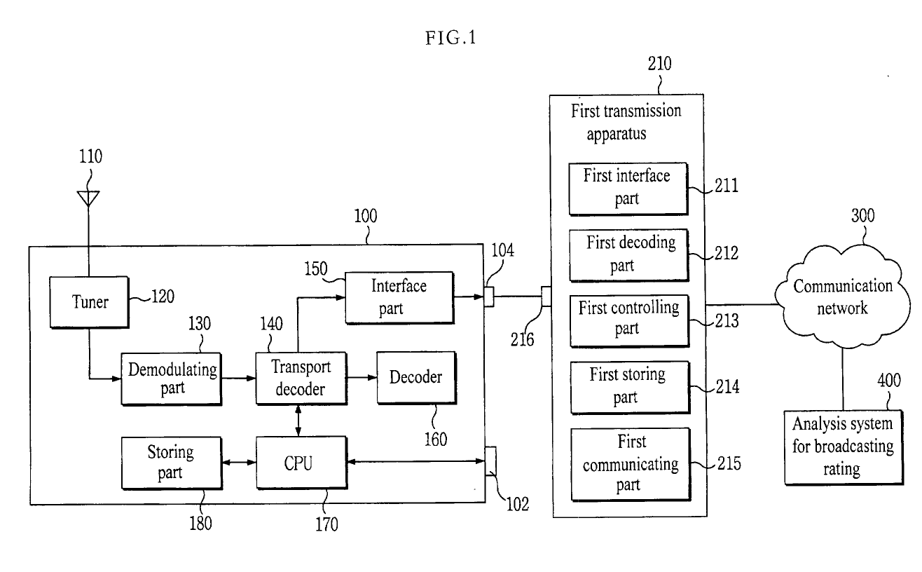

First of all, FIG. 1 is a block diagram illustrating one embodiment of a system for surveying broadcasting rating according to the present invention. Referring to FIG. 1, the present invention is comprised of a first transmission apparatus 210 for receiving transport stream of a channel selected by a user from a digital TV 100, extracting broadcasting channel tuning information so as to generate broadcasting viewing information, and for transmitting the broadcasting viewing information to an analysis system for broadcasting rating 400 via communication network 300. Here, the communication network 300 is preferably an Internet network and the analysis system for broadcasting rating 400 preferably provides a website reflecting analysis results regarding broadcasting rating, to a broadcasting station or an Internet user, etc. connected to the communication network 300.

The first transmission apparatus 210 is comprised of a first interface part 211 for receiving transport stream of a channel selected by a user from a digital TV; a first decoding part 212 for extracting broadcasting channel tuning information from the transport stream; a first controlling part 213 for controlling the first decoding part 212 for extracting the broadcasting channel tuning information and for receiving the broadcasting channel tuning information, generating broadcasting viewing information, and for controlling the broadcasting viewing information to be transmitted to the analysis system for broadcasting rating 400; a first storing part 214 for storing the broadcasting viewing information generated; and a first communicating part 215 for transmitting the broadcasting viewing information to the analysis system for broadcasting rating 400 according to a control of the first controlling part 213.

Preferably, an interface part 150 of the digital TV 100 and the first interface part 211 of the first transmission apparatus 210 support a serial interface like IEEE 1394(Institute of Electrical and Electronic Engineers 1394) and also may be designed to support other interfaces such as USB(Universal Serial Bus), etc.

The first controlling part 213 generates the broadcasting viewing information including broadcasting viewing channel, broadcasting viewing time and user information, and the first transmission apparatus 210 transmits the broadcasting viewing information to the analysis system for broadcasting rating 400 by a predetermined time interval or in real time.

In order to survey broadcasting rating according to age, sex, occupation of a user, it is preferable to receive directly user information from an audience upon channel conversion. Therefore, the first transmission apparatus 210 may have input means supporting a remote control or keypad for receiving user information.

Also, in order to simplify a user information input process, the first transmission apparatus 210 may have each user input a cord previously given to a user by the analysis system for broadcasting rating 400. In that case, information for each user is preferably established as database by the analysis system for broadcasting rating 400.

Preferably, the first communicating part 215 is a modem supporting communication lines such as ADSL(Asymmetric Digital Subscriber Line), cable, Ethernet, etc.

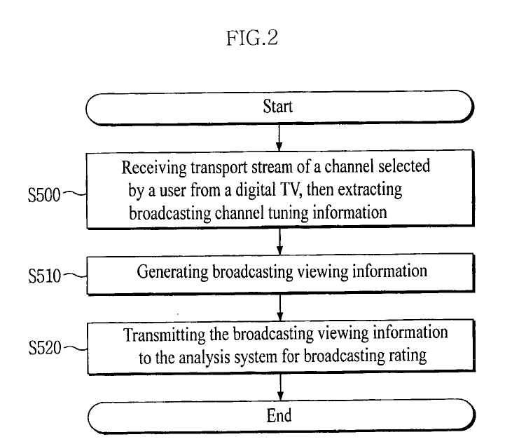

FIG. 2 is a flow chart illustrating a method for surveying broadcasting rating in a system shown in FIG. 1 Referring to FIG. 1 and FIG. 2, the present invention is comprised of the steps of S500 for receiving transport stream of a channel selected by a user from a digital TV, extracting broadcasting channel tuning information; S510 for receiving the broadcasting channel tuning information, generating broadcasting viewing information; and S520 for transmitting the broadcasting viewing information to an analysis system for broadcasting rating 400.

The step of S510 generates the broadcasting viewing information including broadcasting viewing channel, broadcasting viewing time and user information, and the step of S520 transmits the broadcasting viewing information to the analysis system for broadcasting rating 400 by predetermined time interval or in real time.

Detailed description of a process in which broadcasting surveying system having constitution as shown in FIG. 1 surveys broadcasting rating for an audience and transmits survey results to an external analysis system for broadcasting rating, will now be made herein below with reference to FIG. 2.

When an audience selects a broadcasting channel using a remote control or a bottom of the digital TV 100, CPU 170 recognizes channel conversion request and controls a tuner 120 for receiving a signal of relevant frequency from an antenna 110. And CPU 170 controls demodulating part 130 for demodulating and channel decoding the signal from the tuner 120, and the signal provided from the demodulating part 130 has a form of transport stream.

Transport stream consists of a series of transmission packets and these packets have a length of 188 byte long, respectively Each packet normally consists of a header(4 byte) and a payload(144 byte) and the header has packet ID information(PID), which is used for discriminating packets.

After that, CPU 170 controls a transport decoder 140 so as to extract transport stream of the broadcasting channel selected by an audience from the transport stream provided from the demodulating part 130. More detail description of the above process is as follows.

For example, in order for the transport decoder 140 in PSI(Program Specification Information) standard to tune a broadcasting, tables such as PAT(Program Association Table), PMT(Program MAP Table) should be parsed from the transport stream. PAT has a program number representing that what kind of program transport stream is comprised of, and corresponding ID thereto. Also, PMT has content and PID regarding basic stream contained in one program.

When the transport decoder 140 parses PAT and PMT so as to extract transport scream of the broadcasting channel selected by an audience, the interface part 150 transmits the transport stream to an external apparatus. Accordingly, the transport stream of the broadcasting channel selected by an audience is provided to the first transmission apparatus 210 through an output port 104.

In the meantime, the transport decoder 140 extracts the transport scream of the broadcasting channel selected by an audience according to a control of CPU 170, then demultiplexes the same so as to provide it to the decoder 160.

The decoder 160 decodes audio and video signals contained in the transport stream, outputting the same on a screen of the digital TV 100. This process is well known to those skilled in the art that detailed description is omitted in the picture.

The first transmission apparatus 210 receives transport stream output from the digital TV 100 through a first communicating port 216, and the first interface part 211 supports so that the first transmission apparatus 210 may receive the transport stream from the digital TV 100.

Also, the first decoding part 212 extracts broadcasting channel tuning information from the transport stream output from the first interface part 211 according to a control of the first controlling part 213, and the first controlling part 213 receives the broadcasting channel tuning information extracted from the first decoding part 212 and generates broadcasting viewing information (S510).

Here, the broadcasting viewing information includes broadcasting viewing channel, broadcasting viewing time and user information, and the broadcasting viewing information generated by the first controlling part 213 is stored in the first storing part 214.

The first controlling part 213 controls the first decoding part 212 for extracting broadcasting hour information contained in the transport stream, and is able to calculate broadcasting viewing time using the broadcasting hour information.

Also, the first controlling part 213 may be designed to generate broadcasting viewing information including channel conversion time, and may has a separate timer for this. In that case, the first controlling part 213 may also identify the channel conversion time, then storing channel conversion time information in the first storing part 214, calculating broadcasting viewing hour.

Furthermore, the first communicating part 215 transmits the broadcasting viewing information stored in the first storing part 214, to the analysis system for broadcasting rating 400 by predetermined time interval or in real time according to a control of the first controlling part 213(S520).

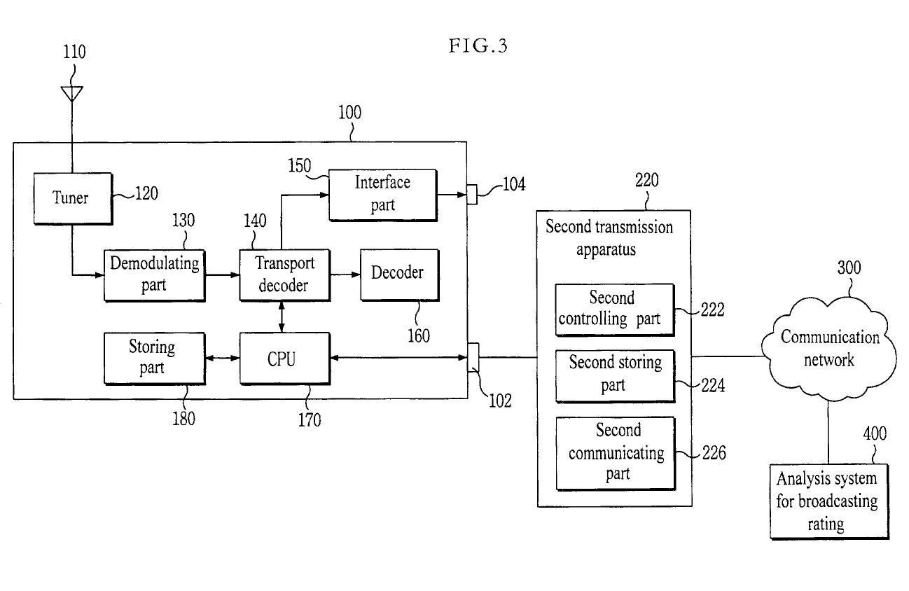

FIG. 3 is a block diagram illustrating another embodiment of a system for surveying broadcasting rating according to the present invention. Referring to FIG. 3, a system for surveying broadcasting rating is comprised of a digital TV having an application for outputting channel conversion controlling information to an internal port 102; and a second transmission apparatus 220 for receiving the channel conversion controlling information from the digital TV 100, generating broadcasting viewing information and for transmitting the broadcasting viewing information to an analysis system for broadcasting rating 400 via communication network 300.

Here, the internal port 102 is preferably a serial port mounted on the digital TV 100, the communication network 300 is preferably an Internet network and the analysis system for broadcasting rating 400 preferably provides a website reflecting analysis results regarding broadcasting rating, to a broadcasting station or an Internet user, etc. connected to the communication network 300.

The digital TV 100 can be given transplantation of the application from outside through the internal port 102, and the second transmission apparatus 220 transmits the broadcasting viewing information to the analysis system for broadcasting rating 400 by predetermined time interval or in real time.

The second transmission apparatus 220 is comprised of a second controlling part 222 for receiving channel conversion controlling information from the digital TV 100, generating broadcasting viewing information, and for controlling the broadcasting viewing information to be transmitted to the analysis system for broadcasting rating 400; a second storing part 224 for storing the broadcasting viewing information; and a second communicating part 226 for transmitting the broadcasting viewing information to the analysis system for broadcasting rating 400 according to a control of the second controlling part 222.

The second controlling part 222 generates the broadcasting viewing information including broadcasting viewing channel, broadcasting viewing time and user information, and the second communicating part 226 is preferably a modem supporting communication lines such as ADSL, cable, Ethernet just like the case in FIG. 1.

Also, the second transmission apparatus 220 may have input means supporting a remote control or keypad for receiving user information and may have each user input a cord previously given to a user by the analysis system for broadcasting rating 400.

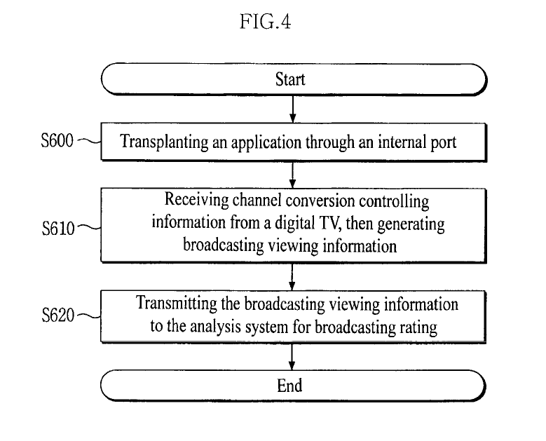

FIG. 4 is a flow chart illustrating a method for surveying broadcasting rating in a system as shown in FIG. 3. Referring to FIG. 3 and FIG. 4, the present invention is comprised of the steps of S600 of transplanting, through the internal port 102, an application for outputting channel conversion controlling information to the internal port 102 of the digital TV 100; S610 of the second transmission apparatus 220 receiving channel conversion controlling information from the digital TV 100, generating broadcasting viewing information; and S620 of transmitting the broadcasting viewing information to the analysis system for broadcasting rating 400.

The step of S610 generates the broadcasting viewing information including broadcasting viewing channel, broadcasting viewing time and user information, and the step of S620 transmits the broadcasting viewing information to the analysis system for broadcasting rating 400 by predetermined time interval or in real time.

Detailed description of a process for surveying broadcasting rating for an audience and transmitting survey results to an external analysis system for broadcasting rating in a broadcasting surveying system having the foregoing constitution, will now be made herein below with reference to FIG. 3 and FIG. 4.

Transplanting, through the internal port 102, the application for outputting channel conversion controlling information to the internal port 102 of the digital TV 100(S600).

The application transplanted through the internal port 102 is mounted on CPU 170 or a storing part 180 of the digital TV 100, and is driven when initialization is performed upon application of power supply to the digital TV 100.

When an audience selects a broadcasting channel using a remote control or a bottom of the digital TV 100, CPU 170 recognizes channel conversion request and controls a tuner 120 for receiving a signal of relevant frequency from an antenna 110 as illustrated in FIG. 1.

Also, CPU 170 controls a demodulating part 130 for demodulating and channel decoding the signal provided from the tuner 120, and controls a transport decoder 140 for extracting transport stream of a broadcasting channel selected by an audience.

While CPU 170 recognizes channel conversion request of an audience, and controls for extracting the transport stream of the relevant broadcasting channel, the application mounted on the digital TV 100 outputs the channel conversion controlling information to the second transmission apparatus 220 through the internal port 102.

For example, while CPU 170 transmits a control signal to the transport decoder 140 for extracting 14-1 broadcasting channel, the application mounted on the digital TV 100 outputs the channel conversion controlling information that the channel is converted to 14-1 channel, to the second transmission apparatus 220 through the internal port 102.

After that, the second controlling part 222 of the second transmission apparatus 220 receives the channel conversion controlling information from the digital TV 100 and generates broadcasting viewing information (S610). Here, the second controlling part 222 generates the broadcasting viewing information including broadcasting viewing channel, broadcasting viewing time and user information just like the case in FIG. 1. As generation of the broadcasting viewing information has been described above in relation to one embodiment of the present invention, description thereto is omitted.

The broadcasting viewing information is stored in the second storing part 224, and a second communicating part 226 transmits the broadcasting viewing information to the analysis system for broadcasting rating 400 by predetermined time interval or in real time according to a control of the second controlling part 222(S620).

As is apparent from the foregoing, according to the present invention it is possible to survey accurately broadcasting rating for digital broadcasting putting various broadcasting programs in one single frequency band, providing the same to an audience, and it is also possible to survey broadcasting rating in real time when necessary.

Furthermore, according to the present invention it is possible to transplant, through an internal port of a digital TV, an application for outputting channel conversion controlling information to the internal port, thereby achieving simple mounting of the application on the digital TV.

Though the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A system for surveying broadcasting rating for surveying digital broadcasting rating so as to provide survey results to an external analysis system for broadcasting rating, the system comprising:
a first transmission apparatus for receiving transport stream of a channel selected by a user from the digital TV, extracting broadcasting channel tuning information so as to generate broadcasting viewing information, and for transmitting the broadcasting viewing information to the analysis system for broadcasting rating.

2. The system as set forth in claim 1, wherein the first transmission apparatus transmits the broadcasting viewing information to the analysis system for broadcasting rating by predetermined time interval or in real time.

3. The system as set forth in claim 1, wherein the first transmission apparatus is comprised of a first interface part for receiving transport stream of the channel from the digital TV; a first decoding part for extracting broadcasting channel tuning information from the transport stream; a first controlling part for controlling the first decoding part for extracting the broadcasting channel tuning information, for receiving the broadcasting channel tuning information, generating broadcasting viewing information, and for controlling the broadcasting viewing information to be transmitted to the analysis system for broadcasting rating; a first storing part for storing the broadcasting viewing information; and a first communicating part for transmitting the broadcasting viewing information to the analysis system for broadcasting rating according to a control of the first controlling part.

4. The system as set forth in claim 2, wherein the first transmission apparatus is comprised of a first interface part for receiving transport stream of the channel from the digital TV; a first decoding part for extracting broadcasting channel tuning information from the transport stream; a first controlling part for controlling the first decoding part for extracting the broadcasting channel tuning information, for receiving the broadcasting channel tuning information, generating broadcasting viewing information, and for controlling the broadcasting viewing information to be transmitted to the analysis system for broadcasting rating; a first storing part for storing the broadcasting viewing information; and a first communicating part for transmitting the broadcasting viewing information to the analysis system for broadcasting rating according to a control of the first controlling part.

5. The system as set forth in claim 3, wherein the first controlling part generates the broadcasting viewing information including broadcasting viewing channel, broadcasting viewing time and user information.

6. A system for surveying broadcasting rating for surveying digital broadcasting rating so as to provide survey results to an external analysis system for broadcasting rating, the system comprising:
a digital TV having an application for outputting a channel conversion controlling information to an internal port; and
a second transmission apparatus for receiving the channel conversion controlling information from the digital TV, generating broadcasting viewing information, and for transmitting the broadcasting viewing information to the analysis system for broadcasting rating.

7. The system as set forth in claim 6, wherein the second transmission apparatus transmits broadcasting viewing information to the analysis system for broadcasting rating by predetermined time interval or in real time.

8. The system as set forth in claim 6, wherein the digital TV can be given transplantation of the application from outside through the internal port.

9. The system as set forth in claim 7, wherein the digital TV can be given transplantation of the application from outside through the internal port.

10. The system as set forth in claim 6, wherein the second controlling apparatus is comprised of a second controlling part for receiving channel conversion controlling information from the digital TV, generating broadcasting viewing information, and for controlling the broadcasting viewing information to be transmitted to the analysis system for broadcasting rating; a second storing part for storing the broadcasting viewing information; and a second communicating part for transmitting the broadcasting viewing information to the analysis system for broadcasting rating according to a control of the second controlling part.

11. The system as set forth in claim 7, wherein the second controlling apparatus is comprised of a second controlling part for receiving channel conversion controlling information from the digital TV, generating broadcasting viewing information, and for controlling the broadcasting viewing information to be transmitted to the analysis system for broadcasting rating; a second storing part for storing the broadcasting viewing information; and a second communicating part for transmitting the broadcasting viewing information to the analysis system for broadcasting rating according to a control of the second controlling part.

12. The system as set forth in claim 10, wherein the second controlling part generates the broadcasting viewing information including broadcasting viewing channel, broadcasting viewing time or hour and user information.

13. A method for surveying broadcasting rating in a broadcasting rating surveying system having a first transmission apparatus for surveying digital broadcasting rating so as to provide survey results to an external analysis system for broadcasting rating, the method comprising the steps of:
(a) receiving transport stream of a channel selected by a user from a digital TV, extracting broadcasting channel tuning information,;
(b) receiving the broadcasting channel tuning information, generating broadcasting viewing information; and
(c) transmitting the broadcasting viewing information to the analysis system for broadcasting rating.

14. The method as set forth in claim 13, wherein the step of (c) transmits the broadcasting viewing information to the analysis system for broadcasting rating by predetermined time interval or in real time.

15. The method as set forth in claim 13, wherein the step of (b) generates the broadcasting viewing information including broadcasting viewing channel, broadcasting viewing time and user information.

16. The method as set forth in claim 14, wherein the step of (b) generates the broadcasting viewing information including broadcasting viewing channel, broadcasting viewing time and user information.

17. A method for surveying broadcasting rating in a broadcasting rating surveying system having a digital TV and a second transmission apparatus for surveying a digital broadcasting rating so as to provide survey results to an external analysis system for broadcasting rating, the method comprising the steps of:
(a) transplanting, through an internal port, an application for outputting channel conversion controlling information to the internal port of the digital TV;
(b) receiving, at the second transmission apparatus, the channel conversion controlling information from the digital TV, and generating broadcasting viewing information; and
(c) transmitting the broadcasting viewing information to the analysis system for broadcasting rating.

18. The method as set forth in claim 17, wherein the step of (c) transmits the broadcasting viewing information to the analysis system for broadcasting rating by predetermined time interval or in real time.

19. The method as set forth in claim 17, wherein the step of (b) generates the broadcasting viewing information including broadcasting viewing channel, broadcasting viewing time or hour and user information.

20. The method as set forth in claim 18, wherein the step of (b) generates the broadcasting viewing information including broadcasting viewing channel, broadcasting viewing time or hour and user information.
